(19) United States
(12) Patent Application Publication
(10) Pub. No.: US 2012/0245270 A1
(43) Pub. Date: Sep. 27, 2012

(54) RUBBER COMPOSITION CONTAINING GLYCEROL AND A FUNCTIONALIZED ELASTOMER AND TREAD FOR A TIRE

(75) Inventors: Christiane Blanchard, Chateaugay (FR); Didier Vasseur, Clermont-Ferrand (FR)

(73) Assignees: MICHELIN RECHERCHE ET TECHNIQUE S.A., Granges-Paccot (CH); SOCIETE DE TECHNOLOGIE MICHELIN, Clermont-Ferrand (FR)

(21) Appl. No.: 13/501,217

(22) PCT Filed: Sep. 13, 2010
(86) PCT No.: PCT/EP2010/063352

§ 371 Date: Jun. 12, 2012

(30) Foreign Application Priority Data
Oct. 12, 2009 (FR) 0957115

(51) Int. Cl. C08L 9/06; C08K 5/053

(52) U.S. Cl. 524/388

(57) ABSTRACT

A reinforced rubber composition, used for the manufacture of treads of tyres, includes (a) a functionalized diene elastomer selected from elastomers that are chain-end functionalized, coupled, or star-branched by a group containing a polar functional group having at least one oxygen atom and block elastomers having at least one polar block, (b) glycerol, and (c) a reinforcing filler that includes an inorganic filler. The rubber composition may impart a low rolling resistance to the tyre treads.

The present invention relates to tyre treads and to rubber compositions used for the manufacture of such treads. It relates more particularly to treads of tyres having a low rolling resistance, predominantly reinforced by reinforcing inorganic fillers.

Since savings in fuel and the need to protect the environment have become a priority, it has proved necessary to produce tyres having a reduced rolling resistance. This has been made possible in particular by virtue of the discovery of novel reinforced rubber compositions having a low hysteresis, synonymous with a lower rolling resistance for the tyres comprising them.

Numerous solutions have already been experimented with in order to achieve this objective of a drop in hysteresis. Mention may in particular be made of the modification of the structure of the diene polymers and copolymers at the end of polymerization by means of functionalization, coupling or star-branching agents with the aim of obtaining a good interaction between the polymer, thus modified, and the filler, whether carbon black or a reinforcing inorganic filler.

By way of illustration of this prior art relating to reinforcing inorganic fillers, mention may be made, for example, of patent EP 0 299 074, which describes functionalized polymers comprising chain-end alkoxysilane functional groups.

Mention may also be made of patents EP 0 692 492 and EP 0 692 493, which describe polymers that are coupled, star-branched, and functionalized at the chain end by modifying agents comprising epoxidized alkoxysilane functional groups.

Another modification of the diene elastomer is that described in patent EP 0 270 071 B1 or in patent application JP 2001/158834 for example. This consists in chain-end functionalizing living diene elastomers via modifying agents comprising amine-containing alkoxysilane functional groups. These amine groups may be tertiary, secondary or primary. In the latter case, application WO 2003/029299 describes a coupling of the diene elastomer via such a modifying agent.

The Applicant companies have described, in patent EP 0 778 311 B1 especially, elastomers comprising, at the chain end, a silanol functional group or a polysiloxane group terminated by a silanol functional group. More recently, the Applicant companies have described, in patent application WO 08/141,702, a monomodal coupled diene elastomer having a silanol functional group in the middle of the chain.

The Applicant companies have also described chain-end functionalized, coupled or star-branched elastomers bearing other functional groups capable of bonding to the reinforcing filler, in particular the inorganic filler, so as to reduce the hysteresis of the rubber composition containing them. Mention may be made, for example, of patent applications EP 0 692 492 A1 and EP 0 692 493 A1 which relates to the modification of diene elastomers by agents of epoxidized alkoxysilane type. More recently, patent application PCT/EP09/055,061 describes the coupling of a diene elastomer by an agent of alkoxysilane type bearing a tertiary or secondary amine functional group.

The Applicant companies have also described block elastomers comprising at least one polar block at the end of the polymer chain or in the middle of the chain capable of achieving hysteresis levels that overall are comparable to those achieved with the modified elastomers mentioned above. Mention may be made, for example, of patent applications EP 1 127 909 A1, WO 09/000,750 and WO 09/000,752.

These modified elastomers were described in the prior art as effective for reducing the hysteresis, which makes them very particularly recommended for use in compositions intended to constitute tyre treads.

Ideally, a tyre tread must meet a large number of technical requirements, while imparting to the tyre a very good level of road handling on a motor vehicle.

To improve the road handling it is known that stiffness of the tread is desirable. However, it turns out that the gain in hysteresis observed with the diene elastomers modified for the purpose of better bonding with the reinforcing filler is usually accompanied by a drop in the stiffness in the cured state.

The objective of the present invention is to reduce the rolling resistance of road tyres without substantially degrading the other properties and especially the road handling.

This objective is achieved in that the Inventors have discovered during their research that a specific rubber composition, based on a modified diene elastomer comprising a polar segment and glycerol, makes it possible to obtain a rubber composition having a reduction in the hysteresis while improving the stiffness relative to a composition that does not comprise a modified elastomer. These significant improvements in the properties make it possible to achieve a very good level of compromise between rolling resistance and road handling of tyres comprising a tread based on such a composition.

Consequently, a first subject of the invention relates to a reinforced rubber composition based on at least (a) one modified diene elastomer bearing a polar segment chosen from elastomers that are chain-end functionalized, coupled or star-branched by a group containing a polar functional group comprising at least one oxygen atom and diene block elastomers comprising at least one polar block, (b) glycerol and (c) one reinforcing filler comprising an inorganic filler.

Another subject of the invention is a tyre tread formed, at least in part, from such a rubber composition.

Another subject of the invention is these tyres themselves, when they comprise a tread in accordance with the invention.

Another subject of the invention is a process for preparing a tyre tread in accordance with the invention.

The expression composition “based on” should be understood to mean, in the present description, a composition comprising the mixture and/or the in situ reaction product of the various constituents used, some of these base constituents (for example the coupling agent, the methylene acceptor and the methylene donor) being capable of reacting or intended to react with one another, at least in part, during the various phases of manufacture of the treads, in particular during the vulcanization (curing) thereof.

In the present description, unless expressly indicated otherwise, all the percentages (%) shown are % by weight. Furthermore, any range of values denoted by the expression “between a and b” represents the field of values ranging from more than a to less than b (that is to say limits a and b excluded) whereas any range of values denoted by the expression “from a to b” means the field of values ranging from a up to b (that is to say including the strict limits a and b).

In the present description, the expression “functionalized diene elastomer” should be understood as meaning a diene elastomer that contains a group comprising one or more heteroatoms, in this instance, in the present case, more particularly an oxygen atom. Within the context of the present description, this group may also be referred to as “functional group”. The two terms are used interchangeably.

This group may be located at the end of the chain. The diene elastomer will then be said to be chain-end functionalized.

This group may be located in the linear main elastomer chain. The diene elastomer will then be said to be coupled or else functionalized in the middle of the chain, as opposed to the “end of the chain” position, even if the group is not located precisely in the middle of the elastomer chain.

This group may be central, in which case n elastomer chains (n>2) are bonded forming a star-shaped structure of the elastomer. The diene elastomer will then be said to be star-branched. According to the invention, this notion of a functionalized diene elastomer does not comprise the functionalization along the elastomer chain by functional groups.

Thus, a first subject of the invention relates to a reinforced rubber composition based on at least (a) one modified diene elastomer bearing a polar segment chosen from elastomers that are chain-end functionalized, coupled or star-branched by a single group containing a polar functional group comprising at least one oxygen atom and diene block elastomers comprising at least one polar block, (b) glycerol and (c) one reinforcing filler comprising an inorganic filler.

The reinforced rubber composition according to the invention may be in the crosslinked state or in the uncrosslinked state, also referred to as the crosslinkable state.

According to the invention, the functionalized diene elastomer may be chosen from elastomers that are chain-end functionalized, coupled or star-branched by a single group containing a polar functional group comprising at least one oxygen atom. This polar functional group may be chosen for example from functional groups of silanol, alkoxysilane, alkoxysilane bearing an amine group, epoxide, ether, ester, hydroxyl, carboxylic acid, etc.

type. This functional group especially improves the interaction between the reinforcing filler comprising an inorganic filler and the elastomer. Such functionalized elastomers are known per se and are described in the prior art.

More particularly, among the diene elastomers functionalized according to the invention, mention may be made of:
elastomers bearing a silanol functional group, the silanol functional group being located either at the end of the chain, or in the middle of the chain. When it is located at the end of the chain, the silanol functional group may be borne by a polysiloxane block.

More particularly suitable as polysiloxane blocks having a silanol end group are, according to the invention, those corresponding to the general formula below:

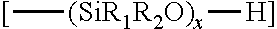

in which:
   R₁ and R₂, which are identical or different, represent an alkyl, cycloalkyl, aryl, alkaryl, aralkyl or vinyl group having from 1 to 10 carbon atoms, preferably an alkyl group having from 1 to 6 carbon atoms,
   x is an integer ranging from 1 to 1500 and preferably from 1 to 50.
Functionalized elastomers of this type are for example described in patent applications EP 0 778 311 A1, EP 0 786 493 A1 and WO 08/141,702.
   chain-end functionalized, coupled or star-branched elastomers resulting from the functionalization of diene elastomers by an agent corresponding to the general formula:

(Y)ₘ—R¹—Si(OR²)₃₋ₙR³.
in which:
Y represents the

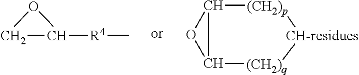

R¹ represents an alkyl, cycloalkyl or aryl residue having from 1 to 10 carbon atoms,
R² represents an alkyl, aryl, cycloalkyl, alkaryl or aralkyl residue having from 1 to 12 carbon atoms,
R³ represents an alkyl, aryl or alkaryl residue having from 1 to 12 carbon atoms,
R⁴ represents a hydrocarbon-based residue having from 1 to 6 carbon atoms and which may comprise one or more oxygen atoms in the hydrocarbon-based chain,
n is an integer chosen from the values 0 or 1,
m is an integer chosen from the values 1 or 2,
p and q are integers chosen from the values 0, 1, 2, 3 or 4, it being understood that the sum p+q should represent an integer between 2 and 5 inclusive.
Functionalized elastomers of this type are for example described in patent applications EP 0 692 492 A1 and EP 0 692 493 A1.
   chain-end functionalized or coupled elastomers resulting from the modification of diene elastomers by an agent of alkoxysilane type bearing a cyclic or noncyclic and tertiary, secondary or primary amine group. Functionalized elastomers of this type are for example described in patent applications US 2005/0203251, JP 2001158834, JP 2005232367, EP 1 457 501 A1 and PCT/EP09/055,061. Advantageously, the diene elastomer thus functionalized is coupled by an alkoxysilane group bonded to the diene elastomer via the silicon atom and bearing an amine radical.

According to the invention, the functionalized diene elastomer may also be chosen from block elastomers comprising at least one polar block, the latter being more particularly a polyether block. These block elastomers comprise at least said polar block at the end of the polymer chain or in the middle of the chain or else these block elastomers may be in star-branched form with at least one central polar block to which several, that is to say more than two, polymer chains are bonded. These block elastomers are generally obtained by reaction of a living diene elastomer with a functionalizing agent having a functional polyether block. Such elastomers are described for example in patent applications EP 1 127 909 A1, WO 09/000,750 and WO 09/000,752.

According to one preferred variant of the invention, the diene elastomer is functionalized or coupled by a group bearing a silanol functional group. More preferably according to this variant, the diene elastomer bears, at the end of the chain, a silanol functional group or a polysiloxane block having a silanol end group.

As is known, the expression “diene elastomer” should be understood to mean an (one or more is understood) elastomer resulting at least partly (i.e., a homopolymer or a copolymer) from diene monomers (monomers bearing two carbon-carbon double bonds which may or may not be conjugated). More particularly, the expression “diene elastomer” is understood to mean any homopolymer obtained by polymerization of a conjugated diene monomer having 4 to 12 carbon atoms, or any copolymer obtained by copolymerization of one or more conjugated dienes with one another or with one or more vinylaromatic compounds having from 8 to 20 carbon atoms. In the case of copolymers, these contain from 20% to 99% by weight of diene units, and from 1% to 80% by weight of vinylaromatic units.

Suitable conjugated dienes that can be used in the process in accordance with the invention are, in particular, 1,3-butadiene, 2-methyl-1,3-butadiene, 2,3-di(C₁-C₅)alkyl-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, phenyl-1,3-butadiene, 1,3-pentadiene, 2,4-hexadiene, etc.

Suitable vinylaromatic compounds are, in particular, styrene, ortho-, meta- and para-methylstyrene, the commercial “vinyl-toluene” mixture, para-(tert-butyl)styrene, methoxy-styrenes, vinylmesitylene, divinylbenzene, vinylnaphthalene, etc.

The diene elastomer of the composition in accordance with the invention is preferably chosen to from the group of highly unsaturated diene elastomers consisting of polybutadienes (BRs), synthetic polyisoprenes (IRs), butadiene copolymers, isoprene copolymers and mixtures of these elastomers.

According to one particular embodiment, the diene elastomer is an SBR, whether it is an SBR prepared in emulsion (“ESBR”) or an SBR prepared in solution (“SSBR”). Use is made in particular of an SBR having a moderate styrene content, for example of between 20% and 35% by weight, or a high styrene content, for example from 35% to 45%, a content of vinyl bonds of the butadiene part of between 15% and 70%, a content (mol %) of trans-1,4- bonds of between 15% and 75% and a T_{g} of between −10° C. and −55° C.; such an SBR can advantageously be used as a mixture with a BR preferably having more than 90% (mol %) of cis-1,4- bonds.

According to another particular embodiment, the diene elastomer is an isoprene elastomer. The expression “isoprene elastomer” is understood, in a known manner, to mean an isoprene homopolymer or copolymer, in other words a diene elastomer chosen from the group consisting of synthetic polyisoprenes (IRs), various isoprene copolymers and mixtures of these elastomers. Mention will in particular be made, among isoprene copolymers, of isoprene/styrene (SIR), isoprene/butadiene (BIR) or isoprene/butadiene/styrene (SBIR) copolymers. This isoprene elastomer is preferably a synthetic cis-1,4-polyisoprene and preferably polyisoprenes having a content (mol %) of cis-1,4- bonds of greater than 90%, more preferably still of greater than 98%.

Particularly suitable are polybutadienes having a content (mol %) of 1,2- units of between 4% and 80% or those having a content (mol %) of cis-1,4- units of greater than 80%, polyisoprenes, butadiene/styrene copolymers and in particular those having a T_{g} (glass transition temperature, measured according to ASTM D3418) of between 0° C. and −80° C. and more particularly between −10° C. and −70° C., a styrene content of between 5% and 60% by weight and more particularly between 20% and 50%, a content (mol %) of 1,2- bonds of the butadiene part of between 4% and 75% and a content (mol %) of trans-1,4- bonds of between 10% and 80%, butadiene/isoprene copolymers and in particular those having an isoprene content of between 5% and 90% by weight and a T_{g} of −40° C. to −80° C., or isoprene/styrene copolymers and in particular those having a styrene content of between 5% and 50% by weight and a T_{g} of between −5° C. and −50° C. In the case of butadiene/styrene/isoprene copolymers, those having a styrene content of between 5% and 50% by weight and an isoprene content of between 15% and 60% by weight, and more generally any butadiene/styrene/isoprene copolymer having a T_{g} of between −20° C. and −70° C., are suitable in particular.

The polymerization of diene monomers is initiated by an initiator. As polymerization initiator, use may be made of any known monofunctional or polyfunctional anionic or non-anionic initiator. However, an initiator containing an alkali metal such as lithium or an alkaline-earth metal such as barium is preferably used. Suitable organolithium initiators are in particular those comprising one or more carbon-lithium bonds. Representative compounds are aliphatic organolithium compounds, such as ethyllithium, n-butyllithium (n-BuLi), isobutyllithium, dilithium polymethylenes such as 1,4-dilithiobutane, etc.

Lithium amides are also preferred initiators since they result in polymers having an amine group at the end or ends of the chains that are not bonded to a functional group as described above or that are not bonded to a polar block. Lithium amide is obtained from an acyclic or cyclic secondary amine, in the latter case pyrrolidine and hexamethyleneimine are highly preferred; it being possible for said amide to be rendered soluble in a hydrocarbon-based solvent owing to the combined use of a solvating agent, an ether for example, as described in patent FR 2 250 774.

Representative compounds that contain barium are those described for example in patent applications FR-A-2 302 311 and FR-A-2 273 822 and the certificates of addition FR-A-2 338 953 and FR-A-2 340 958.

Advantageously according to the invention, the polymerization of diene monomers is initiated by an initiator of lithium amide type in order to introduce an additional amino chain-end functionalization of the elastomer.

The polymerization is, as is known per se, preferably carried out in the presence of an inert solvent, which may, for example, be an aliphatic or alicyclic hydrocarbon such as pentane, hexane, heptane, isooctane or cyclohexane or an aromatic hydrocarbon such as benzene, toluene or xylene.

The polymerization can be carried out continuously or batchwise. The polymerization is generally carried out at a temperature of between 20° C. and 120° C. and preferably in the vicinity of 30° C. to 90° C. A transmetallation agent may, of course, also be added at the end of polymerization to modify the reactivity of the living chain end.

The diene elastomers that are chain-end functionalized, coupled or star-branched by a group comprising a polar functional group containing at least one oxygen atom, used in the invention, may be obtained by various processes that are known per se, in particular that are described in the aforementioned prior art, for example by reaction of the living diene elastomer resulting from the polymerization with a functionalizing, coupling or star-branching agent depending on the desired functionalization of the diene elastomer.

The block elastomers comprising at least one polar block may be obtained by various processes that are described in the prior art, in particular those described in patent applications US 2005/0203251, JP 2001158834, JP 2005232367, EP 1 457 501 A1 and PCT/EP 09/055,061.

It should be understood that the composition of the invention may comprise one or more of these modified diene elastomers bearing a polar segment. Thus, the expression “modified diene elastomers bearing a polar segment” also includes mixtures of these elastomers.

The modified diene elastomer bearing a polar segment, according to the invention, may be used alone in the composition or as a blend with any conventional diene elastomer, as chosen for example from natural rubber, polybutadienes (BRs), synthetic polyisoprenes (IRs), butadiene copolymers, isoprene copolymers and mixtures of these elastomers, whether it is chain-end functionalized, coupled or star-branched, or not, with macrostructure and/or microstructure identical to or different from the modified diene elastomer.

It should be noted that the improvement in the hysteresis properties of the composition according to the invention will be even higher when the proportion, in this composition, of the modified elastomer(s) in accordance with the invention is high. This is why, according to one preferred variant of the invention, the reinforced rubber composition is based on an elastomer matrix comprising predominantly the modified diene elastomer bearing a polar segment in accordance with the invention. The term “predominantly” is understood to mean the highest weight fraction of the matrix, particularly a weight fraction of at least 50% relative to the weight of the matrix. Preferably, the elastomer matrix comprises this modified diene elastomer bearing a polar segment or group in accordance with the invention in an amount greater than or equal to 60 phr (parts by weight per hundred parts of total elastomer), more preferably greater than or equal to 80 phr, or even as the sole diene elastomer with a content equal to 100 phr, maximum elastomer content.

According to the invention, another constituent component of the rubber composition is glycerol.

It is known to lower the viscosity of rubber compositions based on unmodified conventional elastomers by incorporating certain polyols, including glycerol, therein as described by patent EP 0761734 B1.

It is also known to use polar compounds of polyol type in order to improve the grip, on wet ground, of tyres incorporating rubber compositions based on diene elastomers comprising, along the polymer chain, several polar groups, such as essentially nitrile groups. Patent EP 1 253 167 B1 illustrates this prior art.

Nevertheless, none of these prior art documents mentions rubber compositions comprising the specific combination of glycerol and of a modified diene elastomer bearing a polar segment in accordance with the present invention, nor the improvement in the hysteresis properties of such a composition, while improving its stiffness in the cured state or at the very least maintaining it at a satisfactory level.

Advantageously, the glycerol is present in the reinforced rubber composition in amounts ranging from 1 to 10 phr, preferably ranging from 1 to 5 phr.

Another constituent component of the rubber composition according to the invention is the reinforcing filler which comprises an inorganic filler.

The modified diene elastomers bearing a polar segment according to the present invention possess a particular aptitude for being used to constitute rubber compositions predominantly comprising a reinforcing inorganic filler, such as silica. The term “predominantly” is understood to mean the highest weight fraction relative to the total reinforcing filler and preferably a weight fraction of at least 50% relative to the weight of this reinforcing filler, or even at least 70%.

The term “reinforcing inorganic filler” should be understood in the present patent application, by definition, as meaning any inorganic or mineral filler, whatever its colour or its origin (natural or synthetic), also known as “white filler”, “clear filler”, indeed even “non-black filler”, in contrast to carbon black, capable of reinforcing by itself alone, without means other than an intermediate coupling agent, a rubber composition intended for the manufacture of tyres, in other words capable of replacing, in its reinforcing role, a conventional tyre-grade carbon black; such a filler is generally characterized, in a known way, by the presence of hydroxyl (—OH) groups at its surface.

The physical state in which the reinforcing inorganic filler is provided is not important, whether it is in the form of a powder, of microbeads, of granules, of balls or any other appropriate densified form. Of course, the expression “reinforcing inorganic filler” is also understood to mean mixtures of various reinforcing inorganic fillers, in particular of highly dispersible siliceous and/or aluminous fillers as described below.

Suitable reinforcing inorganic fillers are especially mineral fillers of the siliceous type, in particular silica (SiO₂), or of the aluminous type, in particular alumina (Al₂O₃). The silica used may be any reinforcing silica known to a person skilled in the art, especially any precipitated or fumed silica having a BET surface area and also a CTAB specific surface area that are both less than 450 m²/g, preferably from 30 to 400 m²/g. Mention will be made, as highly dispersible (“HDS”) precipitated silicas, for example, of the Ultrasil 7000 and Ultrasil 7005 silicas from Degussa, the Zeosil 1165 MP, 1135 MP and 1115 MP silicas from Rhodia, the Hi-Sil EZ150G silica from PPG, the Zeopol 8715, 8745 and 8755 silicas from Huber or the silicas with a high specific surface area as described in application WO 03/16837.

The reinforcing inorganic filler used, in particular if it is silica, preferably has a BET surface area of between 45 and 400 m²/g, more preferably of between 60 and 300 m²/g.

Besides the inorganic filler, the reinforcing filler may also contain an organic filler, such as carbon black for example, in a minority weight fraction, i.e. a fraction strictly less than 50% by weight of the total weight of the reinforcing filler, or even less than 30%.

Suitable carbon blacks are all carbon blacks, in particular blacks of the HAF, ISAF and SAF types, conventionally used in tyre treads (blacks known as tyre-grade blacks). Among the latter, mention will more particularly be made of reinforcing carbon blacks of the 100, 200 or 300 series (ASTM grades) such as, for example, the blacks N115, N134, N234, N326, N330, N339, N347 and N375. The carbon blacks could, for example, already be incorporated into the modified diene elastomer bearing a polar segment in accordance with the present invention in the form of a masterbatch (see, for example, applications WO 97/36724 or WO 99/16600).

As examples of organic fillers other than carbon blacks, mention may be made of functionalized aromatic vinyl polymer organic fillers as described in applications WO-A-2006/069792 and WO-A-2006/069793, or else the functionalized non-aromatic vinyl polymer organic fillers as described in applications WO-A-2008/003434 and WO-A-2008/003435.

Preferably, the content of total reinforcing filler is between 50 and 200 phr, more preferably between 60 and 140 phr, more preferably still between 70 and 130 phr, the optimum being in a known way different depending on the specific applications targeted: the level of reinforcement expected with regard to a bicycle tyre, for example, is, of course, less than that required with regard to a tyre capable of running at high speed in a sustained manner, for example a motorcycle tyre, a tyre for a passenger vehicle or a tyre for a utility vehicle, such as a heavy vehicle.

According to one embodiment variant of the invention, use is made of a reinforcing filler comprising from 50 to 150 phr, more preferably between 70 and 110 phr, of inorganic filler, particularly silica, and optionally carbon black; the carbon black, when it is present, is preferably used in this variant at a content of between 0 and 30 phr, more preferably between 0 and 20 phr (for example between 0.1 and 10 phr).

In order to couple the reinforcing inorganic filler to the diene elastomer, use is made, in a known way, of an at least bifunctional coupling agent (or bonding agent) intended to provide a satisfactory connection, of chemical and/or physical nature, between the inorganic filler and the diene elastomer, in particular bifunctional organosilanes or polyorganosiloxanes.

Use is made in particular of silane polysulphides, referred to as “symmetrical” or “asymmetrical” depending on their specific structure, as described, for example, in applications WO 03/002648 (or US 2005/016651) and WO 03/002649 (or US 2005/016650).

Suitable in particular, without the definition below being limiting, are symmetrical silane polysulphides corresponding to the following general formula (I):

Z-A′-Sx-A′-Z, (I)

in which:
x is an integer from 2 to 8 (preferably from 2 to 5);
A′ is a divalent hydrocarbon-based radical (preferably C₁-C₁₈ alkylene groups or C₆-C₁₂ arylene groups, more particularly C₁-C₁₀ alkylenes, in particular C₁-C₄ alkylenes, in particular propylene);
Z corresponds to one of the following formulae:

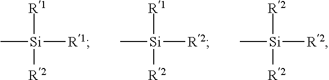

in which:
the substituted or unsubstituted R′1 radicals, which are identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, in particular C₁-C₄ alkyl groups, more particularly methyl and/or ethyl);
the substituted or unsubstituted R′2 radicals, which are identical to or different from one another, represent a C₁-C₁₈ alkoxyl or C₅-C₁₈ cycloalkoxyl group (preferably a group chosen from C₁-C₈ alkoxyls and C₅-C₈ cycloalkoxyls, more preferably still a group chosen from C₁-C₄ alkoxyls, in particular methoxyl and ethoxyl).

Mention will more particularly be made, as examples of silane polysulphides, of bis(3-trimethoxysilylpropyl) or bis(3-triethoxysilylpropyl) polysulphides. Use is in particular made, among these compounds, of bis(3-triethoxysilylpropyl) tetrasulphide, abbreviated to TESPT, or bis(triethoxysilylpropyl) disulphide, abbreviated to TESPD. Mention will also be made, as preferred examples, of bis(mono(C₁-C₄)alkoxyldi(C₁-C₄)alkylsilylpropyl) polysulphides (in particular disulphides, trisulphides or tetrasulphides), more particularly bis(monoethoxydimethylsilylpropyl) tetrasulphide, as described in patent application WO 02/083782 (or US 2004/132880).

Mention will in particular be made, as coupling agent other than alkoxysilane polysulphide, of bifunctional POSs (polyorganosiloxanes) or else of hydroxysilane polysulphides, such as described in patent applications WO 02/30939 (or U.S. Pat. No. 6,774,255) and WO 02/31041 (or US 2004/051210), or else of silanes or POSs bearing azodicarbonyl functional groups, such as described, for example, in patent applications WO 2006/125532, WO 2006/125533 and WO 2006/125534.

In the compositions in accordance with the invention, the content of coupling agent is advantageously less than 20 phr, it being understood that it is generally desirable to use the least amount possible thereof. Its content is preferably between 0.5 and 12 phr, more preferably from 3 to 10 phr, in particular from 4 to 7 phr.

A person skilled in the art will understand that a reinforcing filler of another nature, in particular organic nature, might be used as filler equivalent to the reinforcing inorganic filler described in the present section, provided that this reinforcing filler is covered with an inorganic layer, such as silica, or else comprises, at its surface, functional sites, in particular hydroxyl sites, requiring the use of a coupling agent in order to form the bond between the filler and the elastomer.

The rubber compositions in accordance with the invention may also contain, in addition to coupling agents, coupling activators, agents for covering the inorganic fillers or more generally processing aids capable, in a known manner, by virtue of an improvement in the dispersion of the filler in the rubber matrix and of a reduction in the viscosity of the compositions, of improving their ease of processing in the uncured state, these agents or aids being, for example, hydrolysable silanes such as alkylalkoxysilanes, polyols, polyethers, primary, secondary or tertiary amines, or hydroxylated or hydrolysable polyorganosiloxanes.

The rubber compositions in accordance with the invention may also comprise all or some of the usual additives customarily used in elastomer compositions intended for the manufacture of tyres, such as, for example, pigments, non-reinforcing fillers, protection agents, such as antiozone waxes, chemical antiozonants, antioxidants, antifatigue agents, plasticizing agents, reinforcing or plasticizing resins, methylene acceptors (for example, phenol-novolac resin) or methylene donors (for example, HMT or H3M) as described, for example, in application WO 02/10269, a crosslinking system based either on sulphur or on sulphur donors and/or on peroxide and/or on bismaleimides, vulcanization accelerators and vulcanization activators.

The compositions of the invention may also comprise, as preferred non-aromatic or very weakly aromatic plasticizing agent, at least one hydrocarbon-based resin that is solid at room temperature (23° C.), a liquid plasticizer, or a mixture of the two.

The overall content of such a preferred plasticizing agent is preferably between 5 and 50 phr, more preferably between 10 and 40 phr, especially within a range of 15 to 35 phr.

When the plasticizing agent is a hydrocarbon-based resin having a T_{g} of above 0° C., it preferably has at least any one of the following features, more preferably all three:
a T_{g} of above 20° C., more preferably of above 30° C.;
a number-average molecular weight (Mₙ) of between 400 and 2000 g/mol, more preferably of between 500 and 1500 g/mol;
a polydispersity index (Iₚ) of less than 3, more preferably of less than 2 (reminder: Iₚ=M_{W}/Mₙ with M_{w} the weight-average molecular weight).

The hydrocarbon-based resins may be aliphatic or aromatic or else of aliphatic/aromatic type, that is to say based on aliphatic and/or aromatic monomers. They may be natural or synthetic and may or may not be petroleum-based (if such is the case, also known under the name of petroleum resins).

Suitable aromatic monomers are for example: styrene, α-methylstyrene, ortho-, meta- and para-methylstyrene, vinyltoluene, para-tert-butylstyrene, methoxystyrenes, chlorostyrenes, vinylmesitylene, divinylbenzene, vinylnaphthalene and any vinylaromatic monomer derived from a C₉-cut (or more generally a C₈- to C₁₀-cut). Preferably, the vinylaromatic monomer is styrene or a vinylaromatic monomer derived from a C₉-cut (or more generally a C₈- to C₁₋₁₀-cut). Preferably, the vinylaromatic monomer is the minority monomer, expressed as a mole fraction, in the copolymer in question.

By way of example, the hydrocarbon-based plasticizing resin is chosen from the group formed by cyclopentadiene (abbreviated to CPD) or dicyclopentadiene (abbreviated to DCPD) homopolymer or copolymer resins, terpene homopolymer or copolymer resins, terpene-phenol homopolymer or copolymer resins, C₅-cut homopolymer or copolymer resins, C₉-cut homopolymer or copolymer resins and mixtures of these resins. Mention will especially be made, among the above hydrocarbon-based plasticizing resins of terpene type, of α-pinene, β-pinene, dipentene or polylimonene homopolymer or copolymer resins. These resins can be used as mixtures, alone or in combination with a liquid plasticizer, for example an oil such as MES or TDAE.

The above resins are well known to those skilled in the art and are commercially available. When the plasticizing agent is a plasticizer that is liquid at 20° C., referred to as a “low T_{g} plasticizer”, i.e. which has, by definition, a T_{g} of below −20° C., preferably of below −40° C., any extender oil, whether of aromatic or non-aromatic nature, and any liquid plasticizing agent known for its plasticizing properties with regard to diene elastomers, can be used. Particularly suitable are liquid plasticizers chosen from the group formed by naphthenic oils, especially hydrogenated naphthenic oils, paraffinic oils, MES oils, TDAE oils, ester and ether plasticizers, phosphate and sulphonate plasticizers and plant oils, especially ester plasticizers such as, for example, glycerol trioleates and more particularly oleic sunflower oil, and mixtures of these compounds.

Another subject of the invention is a process for preparing a reinforced rubber composition in accordance with the invention. This process comprises:
(i) carrying out, at a maximum temperature of between 130° C. and 200° C., a first step of thermomechanical working (sometimes described as “non-productive” phase) of the necessary base constituents of said composition, with the exception of the crosslinking system, comprising the modified diene elastomer bearing a polar segment in accordance with the invention, the glycerol and a reinforcing filler, with the exception of a crosslinking system, then
(ii) carrying out, at a temperature lower than said maximum temperature of said first step, preferably of less than 120° C., a second step of mechanical working during which said crosslinking system is incorporated.

The rubber composition thus obtained may then be extruded or calendered in a manner known per se, in the desired form, to manufacture semi-finished articles such as treads.

This process may also comprise, prior to carrying out the aforementioned stages (i) and (ii), the stages of preparing the modified diene elastomer bearing a polar segment in accordance with the invention described above.

Another subject of the invention is a tyre which incorporates, in at least one of its constituent components, a reinforced rubber composition according to the invention, and more particularly semi-finished articles of a tyre which comprise this composition.

Due to the reduced hysteresis and increased stiffness which characterizes a reinforced rubber composition according to the invention in the vulcanized state, it should be noted that a tyre having a tread comprising this composition has an advantageously reduced rolling resistance while imparting to the tyre a very good level of road handling on a motor vehicle. Another subject of the invention is therefore a tyre tread which is such that it comprises a crosslinkable or crosslinked reinforced rubber composition according to the invention, or else is such that it is constituted of this composition, and also its manufacturing process which, besides stages (i) and (ii) described above, also comprises a stage (iii) that consists in extruding or calendering the rubber composition thus obtained, in the form of a tyre tread.

The aforementioned features of the present invention, and others, will be better understood on reading the following description of several exemplary embodiments of the invention, given by way of illustration and without implied limitation.

### I. Measurements and Tests Used

The treads and rubber compositions that are constituents of these treads are characterized, before and after curing, as indicated below.

### I-1. Mooney Plasticity

Use is made of an oscillating consistometer as described in the French standard NF T 43-005 (November 1980). The Mooney plasticity measurement is carried out according to the following principle: the composition in the uncured state (i.e. before curing) is moulded in a cylindrical chamber heated to 100° C. After preheating for one minute, the rotor rotates within the test specimen at 2 rpm and the working torque for maintaining this movement is measured after rotating for 4 minutes. The Mooney plasticity (ML 1+4) is expressed in “Mooney units” (MU, with 1 MU=0.83 Newton·metre).

### 1-2. Shore A Hardness

The Shore A hardness of the compositions after curing is assessed in accordance with the standard ASTM D 2240-86.

### 1-3. Tensile Tests

These tests make it possible to determine the elasticity stresses and the properties at break.

Unless otherwise indicated, they are carried out in accordance with the French standard NF T 46-002 of September 1988. At second elongation (i.e. after an accommodation cycle) the nominal secant moduli (or apparent stresses, in MPa) are measured at 100% elongation (MA100). All these tensile measurements are carried out under standard temperature (23±2° C.) and moisture (50±5% relative humidity) conditions, according to the French standard NF T 40-101 (December 1979). The tensile strengths (in MPa) and the elongations at break (in %) are also measured, at a temperature of 23° C.

### I-4. Dynamic Properties

The dynamic properties G* and tan(δ)ₘₐₓ are measured on a viscosity analyser (Metravib VA4000), according to the ASTM D 5992-96 standard. The response of a sample of vulcanized composition (cylindrical test specimen with a thickness of 4 mm and with a cross section of 400 mm²), subjected to a sinusoidal stress in simple alternating shear, at a frequency of 10 Hz, under normal temperature conditions (40° C.), is recorded according to the ASTM D 1349-99 standard. A scan with a strain amplitude ranging from 0.1% to 50% (forward cycle) then from 50% to 1% (return cycle) is carried out. The results gathered are the complex dynamic shear modulus (G*) and the loss factor (tan(δ)). For the return cycle, the maximum value of tan(δ) observed (tan(δ)ₘₐₓ) between the values at 0.15% and 50% strain (the Payne effect) are indicated.

### II—Elastomer Preparation

Two elastomers are tested in this example. They are two SBRs having a styrene percentage of 25% and a 1,2-vinyl percentage of 58%. They are both functionalized.

1) Preparation of a SiOH chain-end functionalized copolymer A:

Introduced continuously into a 32.5-1 reactor equipped with a turbine-type agitator are cyclohexane, butadiene, styrene and tetrahydrofurfuryl ethyl ether, according to respective mass flow rates of 100/11/3.2/0.037. Sufficient n-butyllithium (n-BuLi) for 100 g of monomers is introduced at the line inlet in order to neutralize the protic impurities introduced by the various constituents present in the line inlet. At the reactor inlet, 530 μmol of n-BuLi per 100 g of monomers are introduced.

The various flow rates are adjusted so that the average residence time in the reactor is 40 min. The temperature is maintained at 70° C.

The degree of conversion, which is measured on a sample withdrawn at the reactor outlet, is 98%.

Finally, at the reactor outlet, 265 micromol, per 100 g of monomers, of hexamethylcyclotrisiloxane in solution in cyclohexane are added to the living polymer solution (on an in-line static mixer). Next, the copolymer is subjected to an antioxidizing treatment using 0.8 phr of 2,2′-methylenebis(4-methyl-6-(tert-butyl)phenol) and 0.2 phr of N-(1,3-dimethylbutyl)-N′-phenyl-p-phenylenediamine.

The copolymer thus treated is separated from its solution by a steam stripping operation and is then dried on an open mill at 100° C. for 20 min, in order to obtain the SiOH chain-end functionalized copolymer.

The ML viscosity of this copolymer A is 53. The molecular weight of the copolymer, determined by conventional SEC, is 123 000 g/mol.

The microstructure of this copolymer A is determined by ¹³C NMR.

The SBR block of this copolymer A contains 25% styrene (by weight) and, for the butadiene part thereof, 58% of vinyl units, 21% of cis-1,4- units and 21% of trans-1,4- units.

2D ¹H—²⁹Si NMR analysis makes it possible to conclude in the existence of an SBR(CH₃)₂SiOH chain-end functional group. The content of (CH₃)₂Si functional groups determined by ¹H NMR for the copolymer A is 5.85 mmol/kg.

2) Preparation of a Copolymer B Functionalized by 3-(glycidyloxypropyl)trimethoxy-silane in the Middle of the Chain:

Introduced continuously into a 32.5-1 reactor equipped with a turbine-type agitator are cyclohexane, butadiene, styrene and tetrahydrofurfuryl ethyl ether, according to respective mass flow rates of 100/11/3.2/0.037. Sufficient n-butyllithium (n-BuLi) for 100 g of monomers is introduced at the line inlet in order to neutralize the protic impurities introduced by the various constituents present in the line inlet. At the reactor inlet, 950 mmol of n-BuLi per 100 g of monomers are introduced.

The various flow rates are adjusted so that the average residence time in the reactor is 40 min. The temperature is maintained at 70° C.

The degree of conversion, which is measured on a sample withdrawn at the reactor outlet, is 95%.

The inherent viscosity, which is measured at 25° C. at 0.1 g/dl in toluene, on a sample withdrawn at the reactor outlet, stopped with an excess of methanol relative to the lithium, is 1.35 dl/g.

Finally, at the reactor outlet, 475 micromol, per 100 g of monomers, of 3-(glycidyloxy-propyl)trimethoxysilane in solution in cyclohexane are added to the living polymer solution (on an in-line static mixer). Next, the copolymer is subjected to an antioxidizing treatment using 0.8 phr of 2,2′-methylenebis(4-methyl-6-(tert-butyl)phenol) and 0.2 phr of N-(1,3-dimethylbutyl)-N′-phenyl-p-phenylenediamine.

The copolymer thus treated is separated from its solution by a steam stripping operation and is then dried on an open mill at 100° C. for 20 min, in order to obtain the copolymer B.

The ML viscosity of this copolymer B is 55. The molecular weight of the copolymer, determined by conventional SEC, is 136 000 g/mol.

The jump in inherent viscosity (ratio of the viscosity after injection of 3-(glycidyloxypropyl)-trimethoxysilane to the viscosity before injection of 3-(glycidyloxypropyl)trimethoxysilane) is 1.33.

The microstructure of this copolymer B is determined by ¹³C NMR.

The SBR block of this copolymer B contains 25% styrene (by weight) and, for the butadiene part thereof, 58% of vinyl units, 21% of cis-1,4- units and 21% of trans-1,4- units.

### III—Preparation of the Compositions

In this example, the two elastomers SBR A and SBR B are SBRs in solution. They are used for the preparation of four rubber compositions A, A+G, B and B+G, as a blend with a BR of predominantly cis microstructure obtained by neodymium catalysis. Compared to the other compositions, compositions A+G and B+G also comprise glycerol. A summary table, Table 1, indicates the exact composition of the compositions tested.

TABLE 1

| | A | A + glycerol | B | B + glycerol |
|---|---|---|---|---|
| Solution SBR A elastomer (1) | 80.00 | 80.00 | | |
| Solution SBR B elastomer (2) | | | 80.00 | 80.00 |
| Solution BR elastomer (3) | 20.00 | 20.00 | 20.00 | 20.00 |
| Black (4) | 2.00 | 2.00 | 2.00 | 2.00 |
| Silica (5) | 75.00 | 75.00 | 75.00 | 75.00 |
| Coupling agent (6) | 6.08 | 6.08 | 6.08 | 6.08 |
| Glycerol 90% | | 3.00 | | 3.00 |
| Plasticizer (7) | 17.00 | 17.00 | 17.00 | 17.00 |
| Stearic acid | 2.00 | 2.00 | 2.00 | 2.00 |
| ZnO (8) | 1.50 | 1.50 | 1.50 | 1.50 |
| Sulphur | 1.20 | 1.20 | 1.20 | 1.20 |
| CBS (9) | 1.60 | 1.60 | 1.60 | 1.60 |
| Diphenylguanidine (10) | 1.30 | 1.30 | 1.30 | 1.30 |
| 6PPD (11) | 1.90 | 1.90 | 1.90 | 1.90 |
| Ozone wax C32 ST | 1.50 | 1.50 | 1.50 | 1.50 |

(1) Elastomer A is an elastomer based on styrene and on butadiene that has a styrene percentage of 25%, a 1,2-vinyl percentage of 58% and that is functionalized at the end of the chain by a chemical functional group of silanol type;
(2) Elastomer B is an elastomer based on styrene and on butadiene that has a styrene percentage of 25%, a 1,2-vinyl percentage of 58% and that is functionalized at the middle of the chain by a chemical functional group of silyl glycidyl ether type;
(3) BR with 4.3% of 1,2-units; 2.7% of trans units; 93% of 1,4-cis units (T_{g} = −106° C.);
(4) Carbon black: N234 (ASTM grade);
(5) silica (“Zeosil 1165 MP” from Rhodia, “HD” type) - (BET and CTAB: about 160 m²/g);
(6) TESTP coupling agent (“Si69” from Degussa);
(7) hydrocarbon-based resin (“Escorez 2101” from Exxon);
(8) zinc oxide (industrial grade - Umicore);
(9) N-cyclohexyl-2-benzothiazylsulphenamide (Santocure CBS from Flexsys);
(10) diphenylguanidine (“Perkacit DPG” from Flexsys);
(11) N-1,3-dimethylbutyl-N-phenyl-para-phenylenediamine (Santoflex 6-PPD from Flexsys).

Each composition is produced by thermomechanical working, in a stage that lasts 5 min, for an average speed of the blades of 50 rpm, in a mixer of around 3 litres until a maximum dropping temperature identical to 165° C. is achieved, while the stage of incorporating the vulcanizing system is carried out on an open mill at 50° C.

The elastomer, the reinforcing filler, the coupling agent, the plasticizer, the antiozone wax, the DPG, the antioxidant, the stearic acid, the glycerol and the zinc monoxide are successively introduced into a laboratory internal mixer of “Banbury” type, the capacity of which is 3 litres, which is 70% filled and which has a starting temperature of approximately 60° C.

The thermomechanical working stage is carried out for 4 to 5 minutes up to a maximum dropping temperature of approximately 165° C.

The aforementioned first step of thermomechanical working is thus carried out, it being specified that the average speed of the blades during this first step is 50 rpm.

The mixture thus obtained is recovered and cooled and then, in an external mixer (homofinisher), the sulphur and the sulphenamide are added at 30° C., the combined mixture being further mixed for a time of 3 to 4 minutes (second aforementioned step of mechanical working).

The compositions thus obtained are subsequently calendered, either in the form of slabs (with a thickness ranging from 2 to 3 mm) or fine sheets of rubber, for the measurement of their physical or mechanical properties, or in the form of profiled elements which can be used directly, after cutting and/or assembling to the desired dimensions, for example as semi-finished products for tyres, in particular for treads.

Crosslinking is carried out at 150° C. for 40 min.

### IV—Tests

These tests demonstrate the improvement in the stiffness of the compositions of tyre treads according to the invention without adversely affecting the hysteresis, compared to a tread of the control test.

The results relating to the properties of the compositions are recorded in Table 2 below.

TABLE 2

| | | | |
|---|---|---|---|
| | A + | | B + |
| A | glycerol | B | glycerol |

Properties in the uncrosslinked state

| | | | | |
|---|---|---|---|---|
| Plasticity ML1 + 4 at 100° C. | 128.7 | 126.2 | 90.3 | 90.9 |
| Fluidity 100 kg | 66.0 | 83.0 | 304.0 | 308.0 |

Properties in the crosslinked state
Static properties

| | | | | |
|---|---|---|---|---|
| Shore A hardness | 67.20 | 71.90 | 68.20 | 73.80 |
| MA100 (MPa) at 23° C. | 2.27 | 3.19 | 2.44 | 3.51 |
| Elongation at break (%) at 23° C. | 500.13 | 407.67 | 522.70 | 434.73 |
| Tensile strength (MPa) at 23° C. | 21.88 | 20.62 | 20.31 | 20.35 |

Dynamic properties in strain

| | | | | |
|---|---|---|---|---|
| TG(D) MAX at 40° C. | 0.223 | 0.208 | 0.231 | 0.238 |
| G* 10% return (MPa) | 2.48 | 2.90 | 2.60 | 3.27 |

Surprisingly, it is observed that the compositions A+glycerol and B+glycerol, which are the subject of the invention, exhibit a great increase in the static moduli of stiffness, namely the Shore hardness and MA100, compared to the corresponding composition A or B without glycerol.

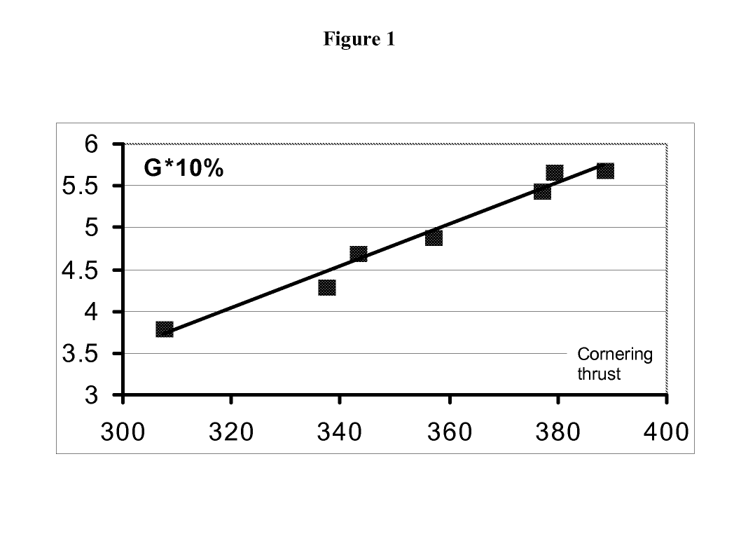

The shear modulus at low strains, denoted by G*10%, and the cornering thrust are correlated as shown by the graph from FIG. 1.

On this graph, it is observed that an increase in the stiffness of the tread through G*10% will have an impact on the cornering thrust of the tyre in order to in fine improve the road handling.

Consistent with the static stiffness measurements, it is observed that in the composition A+glycerol, which is the subject of the invention, the introduction of 3 phr of glycerol results in a stiffening of the matrix via a gain of 0.42 MPa in G* 10% while substantially improving the hysteresis properties since a reduction of 0.015 in tan(δ) is observed.

For the composition B+glycerol, the increase in the moduli is even greater, with a gain of 0.67 MPa in G*10% without adversely affecting the hysteresis, and with an almost unchanged tan(δ).

In conclusion, the introduction of glycerol into the compositions based on a functionalized diene elastomer makes it possible to significantly increase the stiffness, in the cured state, of the mixtures without adversely affecting the hysteresis. This makes it possible to have rubber compositions that exhibit a substantially reduced hysteresis, while improving the stiffness relative to a composition that does not comprise a modified elastomer. These properties suggest that the tyres having a tread that is based on such compositions will exhibit a reduced rolling resistance without substantially degrading the other properties and especially the road handling.

1.-17. (canceled)

18. A reinforced rubber composition comprising:
a functionalized diene elastomer having a polar segment selected from diene elastomers that are chain-end functionalized, coupled, or star-branched by a group that includes a polar functional group having at least one oxygen atom and diene block elastomers having at least one polar block;
glycerol; and
a reinforcing filler,
wherein the reinforcing filler includes an inorganic filler.

19. The reinforced rubber composition of claim 18, wherein the polar functional group is selected from the group consisting of silanol, alkoxysilanes, epoxides, ethers, esters, hydroxyl, carboxylic acid, and alkoxysilanes having an amine group.

20. The reinforced rubber composition of claim 19,
wherein the functionalized diene elastomer has a silanol functional group, and
wherein the silanol functional group is located either at an end of a polymer chain of the functionalized diene elastomer or in a middle portion of the polymer chain.

21. The reinforced rubber composition of claim 19, wherein the functionalized diene elastomer is selected from chain-end functionalized, coupled, or star-branched elastomers resulting from functionalization of diene elastomers by an agent corresponding to a general formula:
(Y)ₘ—R¹—Si(OR²)₃₋ₙ—R³ₙ,
where:
Y represents 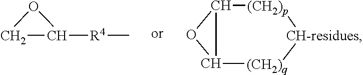
R¹ is selected from the group consisting of alkyl, cycloalkyl, and aryl residue having from 1 to 10 carbon atoms,
R² is selected from the group consisting of alkyl, aryl, cycloalkyl, alkylaryl, and arylalkyl residue having from 1 to 12 carbon atoms,
R³ is selected from the group consisting of alkyl, aryl, and alkylaryl residue having from 1 to 12 carbon atoms,
R⁴ is a hydrocarbon-based residue having from 1 to 6 carbon atoms and may include one or more oxygen atoms in the hydrocarbon-based residue,
n is an integer selected from 0 or 1,
m is an integer selected from 1 or 2, and
p and q are integers selected from 0, 1, 2, 3 or 4, with a sum p+q being an integer between 2 and 5 inclusive.

22. The reinforced rubber composition of claim 19, wherein the functionalized diene elastomer is selected from chain-end functionalized, coupled, or star-branched elastomers resulting from functionalization of diene elastomers by an alkoxysilane agent having a tertiary, secondary, or primary amine group that is cyclic or noncyclic.

23. The reinforced rubber composition of claim 18, wherein the functionalized diene elastomer is selected from a block elastomer that includes at least one polyether block at an end of a polymer chain of the functionalized diene elastomer or in a middle portion of the polymer chain, and block elastomer that includes at least one central polar block to which more than two polymer chains are bonded.

24. The reinforced rubber composition of any one of claims 18, 19, and 23, wherein the functionalized diene elastomer includes an amine functional group at a polymer chain end or at polymer chain ends not bonded to the polar segment.

25. The reinforced rubber composition of claim 24, wherein the amine functional group is derived from pyrrolidine or hexamethyleneimine.

26. The reinforced rubber composition of claim 18, wherein the functionalized diene elastomer is a functionalized butadiene-styrene copolymer.

27. The reinforced rubber composition of claim 18, wherein the glycerol is present in an amount from 1 to 10 phr.

28. The reinforced rubber composition of claim 18, wherein the reinforcing filler predominantly includes an inorganic filler.

29. The reinforced rubber composition of claim 18 or 28, wherein the reinforcing filler is silica.

30. The reinforced rubber composition of claim 18, further comprising a conventional diene elastomer.

31. The reinforced rubber composition of claim 18, wherein the reinforced rubber composition is a crosslinkable or crosslinked rubber composition incorporated in a semi-finished tyre rubber article.

32. The reinforced rubber composition of claim 31, wherein the semi-finished tyre rubber article is a tyre tread.

33. The reinforced rubber composition of claim 31, wherein the semi-finished tyre rubber article is incorporated in a tyre.

34. A process for preparing a tyre tread formed from at least a rubber composition that includes: a functionalized diene elastomer having a polar segment selected from diene elastomers that are chain-end functionalized, coupled, or star-branched by a group that includes a polar functional group having at least one oxygen atom and diene block elastomers having at least one polar block; glycerol; and a reinforcing filler, wherein the reinforcing filler includes an inorganic filler, the process comprising steps of:
thermomechanical working, at a maximum temperature of between 130° C. and 200° C., of the functionalized diene elastomer, the glycerol, and the reinforcing filler of the rubber composition, resulting in a first product;
after the thermomechanical working step, mechanical working of the first product to incorporate a crosslinking system, at a temperature lower than the maximum temperature of the thermomechanical working step, resulting in the rubber composition; and
extruding or calendering the rubber composition obtained from the mechanical working step, to form the tyre tread.
